(19) United States
(12) Patent Application Publication
(10) Pub. No.: US 2026/0322051 A1
(43) Pub. Date: Oct. 15, 2026

(54) UNIVERSAL POWER DISTRIBUTOR AND DEVICE MOUNT

(71) Applicant: International Truck Intellectual Property Company, LLC, Lisle, IL (US)

(72) Inventors: Michael J. Muff, Plainfield, IL (US); Lance Michael Coley, Aurora, IL (US)

(73) Assignee: International Truck Intellectual Property Company, LLC, Lisle, IL (US)

(21) Appl. No.: 19/175,174

(22) Filed: Apr. 10, 2025

(51) Int. Cl. H01R 27/02; B60R 16/02; B60R 16/03

(52) U.S. Cl. CPC H01R 27/02; B60R 16/0215; B60R 16/03; H01R 2201/26

(57) ABSTRACT

A power distribution assembly for a vehicle includes an electrical distribution port (EDP) located in a first housing mounted on an interior surface of a vehicle cabin and having a first pinout matrix and a body wire harness extending from the inside of the first housing away from the interior of the vehicle cabin, the body wire harness connecting the first pinout matrix to a body control module; and a power distribution mount (PDM) located in a second housing that is removably attachable to the first housing, the PDM having a second pinout matrix at a rear side of the second housing and a plurality of sets of power receptacles at a front side of the second housing opposite the rear side of the second housing. The plurality of sets of power receptacles are removably attachable to the vehicle cabin and the body control module.

### FIELD OF THE DISCLOSURE

The present disclosure relates generally to power distribution systems, and more particularly to a universal power distributor and device mount for user devices inside a vehicle.

### BACKGROUND

Vehicle space is very limited in sleeper cabins. For example, there is an interest in permanently mounting a fan on high-rise roofs of sleeper cabins in long haul trucks. Unfortunately, there are significant packaging issues driven by carry over components which cannot be modified, other components such as overhead lighting occupying interior sleeper cabin real estate and large-swing envelopes for cabinets and stowaway bunks further limiting the available mounting locations. Space limitations have developed as an increasing issue due to the increased complexity within vehicle cabins as consumers are offered more and more content that is modular for cross-platform utilization. As sleeper cabins continue to move forward in evolution, spacing limitations will continue to grow more problematic. Therefore, a need exists for improved power distribution and device mounting solutions.

### SUMMARY OF THE INVENTION

According to a first aspect of the present disclosure, a power distribution assembly for a vehicle includes an electrical distribution port located in a first housing mounted on an interior surface of a vehicle cabin, the first housing having at least one first attachment member and the electrical distribution port having a first pinout matrix extending from inside the first housing toward an interior of the vehicle cabin and a body wire harness extending from the inside of the first housing away from the interior of the vehicle cabin, the body wire harness connecting the first pinout matrix to a body control module; and a power distribution mount located in a second housing that is removably attachable to the first housing, the second housing having at least one second attachment member and the power distribution mount having a second pinout matrix at a rear side of the second housing and a plurality of sets of power receptacles at a front side of the second housing opposite the rear side of the second housing. The first aspect can further include, as a result of the second housing attaching to the first housing by locking the at least one second attachment member to the at least one first attachment member, the plurality of sets of power receptacles are attached to the vehicle cabin and the second pinout matrix connects the plurality of sets of power receptacles to the body control module; and as a result of the second housing detaching from the first housing by unlocking the at least one second attachment member from the at least one first attachment member, the plurality of sets of power receptacles are detached from the vehicle cabin and disconnected from the body control module.

In one embodiment of the first aspect, the second housing comprises a device mounting surface sized and shaped to receive and support a device mount thereon and at least one electronic user device attached to the device mount. In another embodiment of the first aspect, as the result of the at least one second attachment member locking to the at least one first attachment member, the second pinout matrix connects to the first pinout matrix for supplying data and power from at least one data and power source inside the vehicle to the at least one electronic user device that is plugged into at least one of the plurality of sets of power receptacles.

In yet another embodiment of the first aspect, the device mounting surface comprises a threaded quick-release attachment for the device mount. In another embodiment of the first aspect, each set of the plurality of sets of power receptacles are different from one another. In another embodiment of the first aspect, the plurality of sets of power receptacles comprises a first set of charging ports, a second set of three-prong power outlets and a third set of display ports. In another embodiment of the first aspect, one of the at least one first and second attachment members is a female attachment member and the other of the at least one first and second attachment members is a mating male attachment member.

In another embodiment of the first aspect, the at least one second attachment member rotationally locks to the at least one first attachment member. In an embodiment of the first aspect, the rear side of the second housing is sized and shape to mate with a front side of the first housing when the at least one second and first attachment members are locked together. In yet another embodiment of the first aspect, the second housing is sized and shaped to conceal the first housing when the at least one second and first attachment members are locked together.

According to a second aspect, a power distribution assembly for a vehicle is provided. The power distribution assembly includes an electrical distribution port located in a first housing mounted on an interior surface of a vehicle cabin, the first housing having at least one first attachment member and the electrical distribution port having a first pinout matrix extending from inside the first housing toward an interior of the vehicle cabin and a body wire harness extending from the inside of the first housing away from the interior of the vehicle cabin, the body wire harness connecting the first pinout matrix to a body control module, wherein a power distribution mount located inside a second housing is removably attachable to the first housing, the second housing having at least one second attachment member and the power distribution mount having a second pinout matrix at a rear side of the second housing and a plurality of sets of power receptacles at a front side of the second housing opposite the rear side of the second housing. According to the second aspect, as a result of the second housing attaching to the first housing by locking the at least one second attachment member to the at least one first attachment member, the plurality of sets of power receptacles are attached to the vehicle cabin and the second pinout matrix connects the plurality of sets of power receptacles to the body control module; and as a result of the second housing detaching from the first housing by unlocking the at least one second attachment member from the at least one first attachment member, the plurality of sets of power receptacles are detached from the vehicle cabin and disconnected from the body control module.

In one embodiment of the second aspect, the electrical distribution port comprises a connector configured to connect the body wire harness to the body control module. In one embodiment of the second aspect, as the result of the at least one second attachment member locking to the at least one first attachment member, the second pinout matrix connects to the first pinout matrix for supplying data and power from at least one data and power source inside the vehicle to at least one electronic user device that is plugged into at least one of the plurality of sets of power receptacles. In one embodiment of the second aspect, one of the at least one first and second attachment members is a female attachment member and the other of the at least one first and second attachment members is a mating male attachment member.

According to a third aspect of the present disclosure, a power distribution assembly for a vehicle includes an electrical distribution port located in a first housing mounted on an interior surface of a vehicle cabin, the first housing having at least one first attachment member and the electrical distribution port having a first pinout matrix extending from inside the first housing toward an interior of the vehicle cabin and a body wire harness extending from the inside of the first housing away from the interior of the vehicle cabin; and a power distribution mount located in a second housing that is removably attachable to the first housing, the second housing having at least one second attachment member and the power distribution mount having a second pinout matrix at a rear side of the second housing and a plurality of sets of power receptacles at a front side of the second housing opposite the rear side of the second housing. According to the third aspect, as a result of the second housing attaching to the first housing by locking the at least one second attachment member to the at least one first attachment member, the plurality of sets of power receptacles are attached to the vehicle cabin and the second pinout matrix connects the plurality of sets of power receptacles to the first pinout matrix; and as a result of the second housing detaching from the first housing by unlocking the at least one second attachment member from the at least one first attachment member, the plurality of sets of power receptacles are detached from the vehicle cabin and disconnected from the first pinout matrix.

In one embodiment of the third aspect, as the result of the at least one second attachment member locking to the at least one first attachment member, the second pinout matrix connects to the first pinout matrix for supplying data and power from at least one data and power source inside the vehicle to at least one electronic user device that is plugged into at least one of the plurality of sets of power receptacles. In one embodiment of the third aspect, each set of the plurality of sets of power receptacles are different from one another. In one embodiment of the third aspect, one of the at least one first and second attachment members is a female attachment member and the other of the at least one first and second attachment members is a mating male attachment member.

In one embodiment of the third aspect, the rear side of the second housing is sized and shape to mate with a front side of the first housing when the at least one second and first attachment members are locked together. In one embodiment of the third aspect, the second housing is sized and shaped to conceal the first housing when the at least one second and first attachment members are locked together.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope.

FIG. 1 is a top plan view of an electrical distribution port (EDP) in accordance with a representative embodiment of the present disclosure.

FIG. 2 is a cross-sectional side elevation view of the EDP introduced in FIG. 1 in accordance with a representative embodiment of the present disclosure.

FIG. 3 is a top plan view of a power distribution mount (PDM) in accordance with a representative embodiment of the present disclosure.

FIG. 4 is a cross-sectional side elevation view of the PDM introduced in FIG. 2 in accordance with a representative embodiment of the present disclosure.

FIG. 5 is a cross-sectional side elevation view of the PDM assembled to the EDP in accordance with a representative embodiment of the present disclosure.

FIG. 6 is a schematic diagram of a multi-port system integrated with a vehicle entertainment system and controls according to a representative alternative embodiment of the present disclosure.

FIG. 7 is a schematic diagram of a power distribution and device mounting system inside a vehicle cabin according to a representative embodiment of the present disclosure.

In the following detailed description, various embodiments are described with reference to the appended drawings. Those of ordinary skill in the art will appreciate that the drawings are illustrated for simplicity and clarity and therefore may not be drawn to scale and may not include well-known features, that the order of occurrence of actions or steps may be different than the order described or may be performed concurrently unless specified otherwise, and that the terms and expressions used herein have the meaning understood by those of ordinary skill in the art except where different meanings are attributed to them herein. Like reference numerals refer to like elements or components throughout. Like elements or components will therefore not necessarily be described in detail with respect to each figure.

### DETAILED DESCRIPTION

The present disclosure relates to a power distribution and device mounting assembly having a 2-part design. The assembly includes an electrical distribution port (EDP), integrated with the interior of the vehicle and a plug-and-play with the vehicle body wire harness. The EDP is configured to supply standard home outlet power, as well as visual/audio data. The assembly further includes a power distribution mount (PDM) with a quick-connect to the EDP, without any tools required. The PDM has universal device mounting and supplies the physical outlets and receptacles to distribute power, video, and audio data. The PDM is configured to work with all EDPs in a vehicle. End-of-arm tooling (EOTA) allows off-the-shelf mounting solutions that integrate with the PDM.

The power distribution and device mounting assembly provides an integrated power and data distribution system throughout the interior of the vehicle cabin that enables modularity for any type of user device being operated and the location such user device(s) can be mounted to. Functionality of the interior cabin can be increased through enabling more existing user devices to be integrated into the vehicle's functionality. The 2-part design allows EDPs to be minimalized to maintain individualized styling, such as choreographed lighting, LEDs in the EDP or PDM, greeting/mood setting capability, and the like. Additional functionality can be provided by integrating the 2-part assembly to onboard entertainment system, such as, webcasting to the entertainment system, which then broadcasts video/audio data to receiving EDPs set up with monitors, speakers, and the like. Once integrated with the onboard entertainment system, even more personalization can be provided, such as, dynamic mood lighting synchronized with music, etc. The present disclosure allows supplying power, data and device mounting to evolve according to the passenger's power needs within the confines of the vehicle cabin.

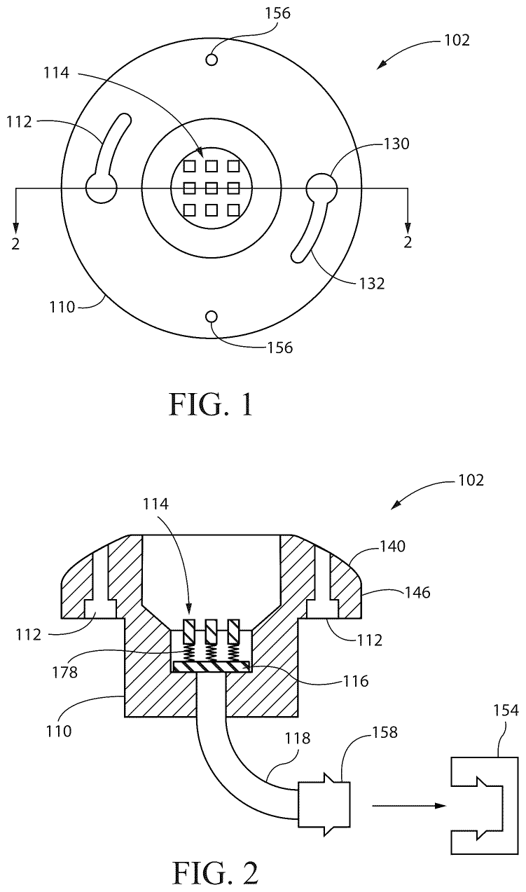

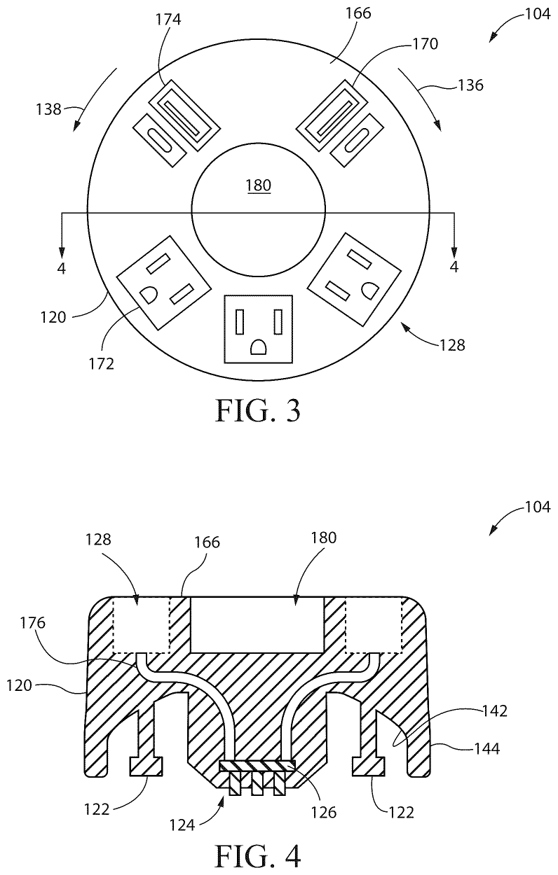

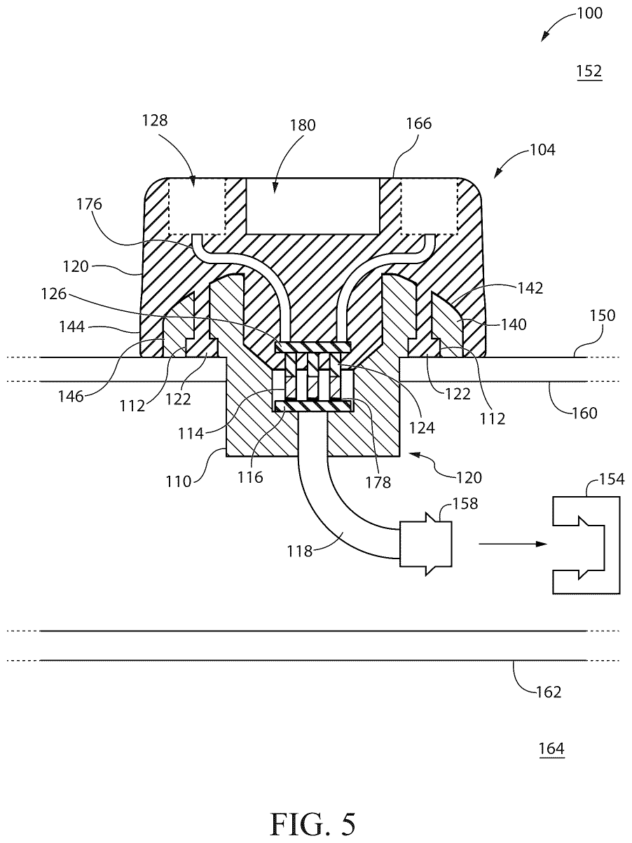

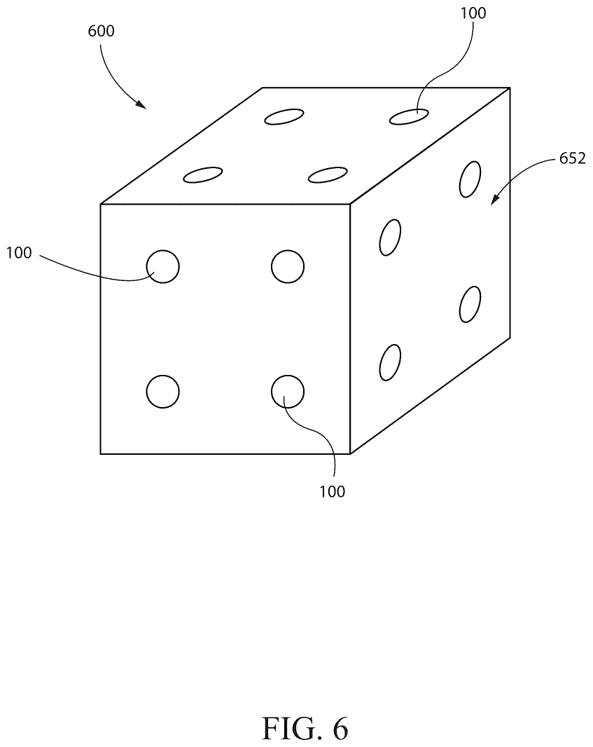

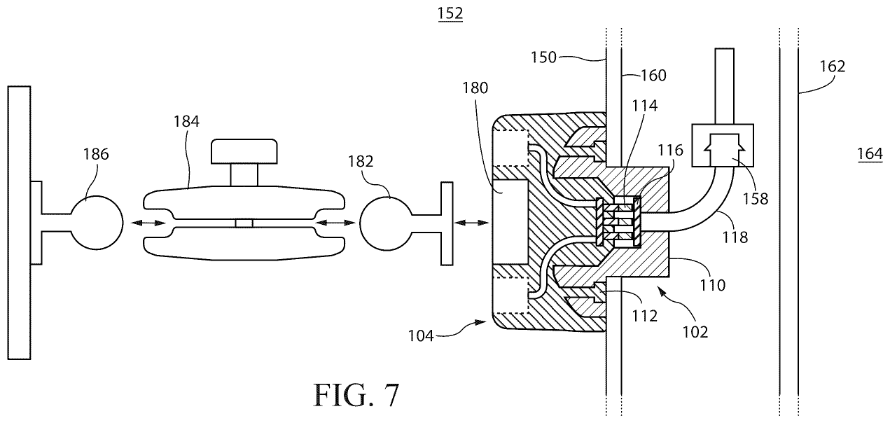

PDM removably locks into any of the EDPs inside the cabin, while EDPs can be replaceable by simply removing mounting screws and releasing the electrical quick connect. FIGS. 1-7 illustrate a power distribution assembly 100 for a vehicle according to embodiments of the present disclosure. Power distribution assembly 100 includes an electrical distribution port (EDP) 102 that is selectively connectable to a power distribution mount (PDM) 104. FIGS. 1 and 2 illustrate EDP 102 (unattached from PDM 104). FIGS. 3 and 4 illustrate PDM 104 (unattached from EDP 102). FIG. 5 shows EDP 102 attached to PDM 104. And FIGS. 6 and 7 illustrate aspects of mounting within the cabin.

Referring initially to FIG. 5 in which EDP 102 and PDM 104 are in an attached configuration, EDP 102 is located in a first housing 110 having a pair of first attachment members 112. EDP 102 further includes a first pinout matrix 114 connected to a first pinout bus 116 and a body wire harness 118. PDM 104 is located in a second housing 120 having a pair of second attachment members 122. PDM 104 further includes a second pinout matrix 124 connected to a second pinout bus 126 and a plurality of sets of power receptacles 128. Each of the pair of first attachment members 112 is a female attachment member sized and shaped to receive each of the pair of corresponding second attachment members 122 which are mating male attachment members that are sized and shaped to rotationally lock into the female attachment members.

Referring now to FIGS. 1-4, certain aspects can be more clearly observed with the EDP 102 and PDM 104 unattached from one another. As seen in FIGS. 1 and 2 (unattached EDP 102), first attachment members 112 of EDP 102 are recessed slots in the first housing 110, each having an insertion slot portion 130 that is wider than a locking slot portion 132. Second attachment members 122 (see FIG. 4) of PDM 104 can be inserted into the corresponding insertion slot portion 130 (see FIG. 1) of EDP 102 which is sufficiently wide to receive second attachment members 122 therein. In the plan views of FIGS. 1 and 3, it can be observed that second housing 120 (see FIG. 3) can be locked to first housing 110 (see FIG. 1) by slidably rotating second housing 120 in a clockwise direction 136. In FIGS. 1 and 4, it can be observed that such sliding rotation of first housing 110 also rotates second attachment members 122 (see FIG. 4) of PDM 104 into the narrower locking slot portions 132 (see FIG. 1) of EDP 102, thereby locking the attachment members 112, 122 together and the first housing 110 to the second housing 120. The resulting locking engagement is shown in FIG. 5.

Referring now primarily to the top plan views of FIGS. 1 and 3, with brief reference to the side elevation view of FIG. 4, second housing 120 can subsequently be selectively detached from first housing 110 by unlocking second attachment members 122 (FIG. 4) from first attachment members 112. This can be achieved by slidably rotating second housing 120 in a counterclockwise direction 138, which rotates second attachment members 122 (FIG. 4) from the narrow locking slot portions 132 of first attachment members 112 to the larger insertion slot portions 130 of first attachment members 112; thereby allowing the second housing 120 to be removed. In alternative embodiments, attachment members on PDM housing can be female attachment members while attachment members on EDP housing can be male attachment members. Other alternative embodiments can use other types of selective attachment configurations as long as the PDM and EDP housings can be selectively attached and detached in a user-friendly and relatively quick manner, without the need for tools.

Referring again primarily to FIG. 5 in which EDP 102 and PDM 104 are in an attached configuration, with brief reference to FIGS. 1-4 in which certain aspects can be more clearly observed in the unattached configurations, a front side 140 of first housing 110 is sized and shaped to mate with a rear side 142 of second housing 120 when the first and second attachment members 112, 122 are locked together. As seen best in FIGS. 1 and 2, front side 140 of first housing 110 has a generally round, spherical profile with a circular center section that is recessed; while (see FIGS. 3 and 4) rear side 142 of second housing 120 has a generally round, spherical negative profile with a circular center section that is protruding. In FIG. 5, it can be observed that the front side 140 of first housing 110 is approximately the negative or inverse of rear side 142 of second housing 120 so that the two housings can be selectively locked together giving the appearance of a single unit; yet also selectively detachable.

Referring still to FIG. 5, in a preferred embodiment, second housing 120 is sized and shaped to conceal first housing 110 when the first and second attachment members 112, 122 are locked together. Bottom edge 144 of second housing 120 is an over-hang that provides an extra circumferential sidewall concealing bottom edge 146 of first housing 110 when the housings 110, 120 are selectively attached together. In alternative embodiments, second housing 120 can conceal first housing 110 in other ways when selectively attached together.

Referring now to FIG. 7, mounting aspects of EDP 102 are discussed. EDP 102 is mounted to the cabin wall and partially extending into the hollow defined by the inner and outer walls of the cabin. EDP 102 is located in first housing 110 which is mounted on an interior surface 150 of a vehicle cabin 152. First housing 110 has first attachment members 112. EDP 102 has first pinout matrix 114 extending from inside first housing 110 toward an interior of the vehicle cabin 152 and a body wire harness 118 extending from inside first housing 110 away from the interior of the vehicle cabin 152. Body wire harness 118 connects first pinout matrix 114 and first pinout bus 116 to a body control module 154 inside the vehicle. Body control module 154 is an electronic control unit that manages a vehicle's electrical systems, such as, for example, lighting, climate control, power windows, etc. and maintains communication between integrated control units via the vehicle bus system.

Referring still to FIG. 7, with brief reference to FIGS. 1 and 5, first housing 110 of EDP 102 includes a pair of apertures 156 (see FIG. 1) and first housing 110 is mounted on the interior surface 150 of the vehicle cabin 152 via a pair of mounting screws (not shown) threaded through the pair of apertures 156 (see FIG. 1). Thus, while second housing 120 is selectively attachable to first housing 110, as described herein above with reference to FIG. 5; first housing 110 is fixed to the vehicle cabin 152. In alternative embodiments, first housing 110 can be fixed to the vehicle cabin 152 in other ways. First housing 110 has a plastic body but may be made of other materials conventionally used inside a vehicle cabin.

Referring still to FIG. 7, EDP 102 further includes a connector 158 at an end of the body wire harness 118. Connector 158 and body wire harness 118 are interposed between an internal vehicle cabin panel 160 and an external vehicle panel 162 facing outside 164. The connector 158 is configured to connect body wire harness 118 to body control module 154. In a preferred embodiment, connector 158 is an electrical quick-connect connection at the end of the body wire harness 118 connecting EDP 102 to the body control module 154.

Referring now primarily to FIGS. 3 and 4, PDM 104 is located inside second housing 120 which is removably attachable to first housing 110 via second attachment members 122, as described herein above. PDM 104 has second pinout matrix 124 and second pinout bus 126 at rear side 142 of second housing 120 and a plurality of sets of power receptacles 128 at a front side 166 of second housing 120, which is opposite the rear side 142.

Both pinout matrices 114 and 124 and pinout buses 116 and 126 correspond to power and/or data lines required to supply power and/or data to user devices via the plurality of sets of power receptacles 128, from the body control module 154. The plurality of sets of power receptacles 128 are different from one another. First set 170 includes two charging ports (e.g., micro-USB-C and a lightening port). Second set 172 includes three three-prong standard power outlets. Third set 174 includes two display ports (e.g., HDMI, DP). Conductors 176 extend from the power receptacles 128 to pinout bus 126 and pinout matrix 124, which should have the number, arrangement and types of pinouts required for all the particular power receptacles 128 on PDM 104. The ones shown in FIG. 3 are non-limiting examples. Other types and numbers of power receptacles can be provided in PDM in alternative embodiments.

Pinout bus 116 and pinout matrix 114 in first housing 110 should also have the number, arrangement and types of pinouts required for the power receptacles 128 at second housing 120 and those should match to pinout bus 126 and pinout matrix 124 such that when first and second attachment members 112, 122 are locked together, as described herein above, the plurality of sets of power receptacles 128 are electrically connected to the body control module 154 and power and/or data can be received therefrom. Referring briefly to FIGS. 2 and 5, pinout matrix 114 is spring loaded, having springs 178 interposed between the pinout matrix 114 and pinout bus 116; while pinout matrix 124 and pinout bus 126 is fixed. Such spring loading may also assist in locking PDM 104 to EDP 102.

FIG. 7 illustrates a user device mounting arrangement according to one embodiment of the present disclosure. Second housing 120 has a device mounting surface 180 that is sized and shaped to receive and support one or more device mounts thereon and one or more electronic user devices (e.g., smartphone, computer tablet, iPad, smart TV, computer monitor, etc.) attached to the device mounts. Device mounting surface 180 preferably has a threaded quick-release attachment that allows users to use conventional off-the-shelf mounting solutions in a quick and user-friendly manner. Device mounting surface 180 includes a circular recessed portion of second housing 120. A round plate mount 182 can be attached to the device mounting surface 180. A dual-receptacle arm 184 can attach an electronic device holder 186 to the round plate mount 182. Other types of user device mounting arrangements can be provided at second housing in alternative embodiments.

Referring now primarily to FIG. 6, a multi-port system 600 is shown in accordance with an embodiment of the present disclosure. A representation of a vehicle cabin 652 is shown defined by four sidewall panels (two not shown), a roof panel and a floor panel (not shown). As can be seen in FIG. 6, vehicle cabin 652 can be equipped with a plurality of locations for multiple power distribution assemblies 100. There can be provided, for example, power distribution assembly 100 integrated into the roof panel to provide power and connection to fans and overhead LED lighting inside the vehicle cabin 652. There can also be provided power distribution assembly 100 integrated into a top part of sidewall panel to provide power, data and connection to a smart TV and speakers. There can also be provided power distribution assembly 100 integrated into a bottom corner of sidewall panel to provide power and connection to a microwave and blender. These are non-limiting examples. Power and data may be routed from one or more power and data sources inside the vehicle (e.g., EV battery, onboard system), through one or more body control modules 154. In some embodiments, the multi-port system 600 is integrated with the vehicle's onboard entertainment system and controls. In some embodiments, a vehicle is configured with a predetermined amount of EDPs (e.g., 12), while the amount of removably attachable PDMs can be user-selected based on the user's evolving needs.

While the disclosure and what is presently considered to be the best mode thereof has been described in a manner establishing possession and enabling those of ordinary skill in the art to make and use the same, it will be understood and appreciated that there are many equivalents to the select embodiments described herein and that myriad modifications and variations may be made thereto without departing from the scope and spirit of the disclosure, which is to be limited not by the embodiments described herein but by the appended claims and their equivalents. For example, various components of the embodiments may be interchanged, added, or substituted in the other embodiments.

What is claimed is:

1. A power distribution assembly for a vehicle comprising:
an electrical distribution port located in a first housing mounted on an interior surface of a vehicle cabin, the first housing having at least one first attachment member and the electrical distribution port having a first pinout matrix extending from inside the first housing toward an interior of the vehicle cabin and a body wire harness extending from the inside of the first housing away from the interior of the vehicle cabin, the body wire harness connecting the first pinout matrix to a body control module; and
a power distribution mount located in a second housing that is removably attachable to the first housing, the second housing having at least one second attachment member and the power distribution mount having a second pinout matrix at a rear side of the second housing and a plurality of sets of power receptacles at a front side of the second housing opposite the rear side of the second housing;
as a result of the second housing attaching to the first housing by locking the at least one second attachment member to the at least one first attachment member, the plurality of sets of power receptacles are attached to the vehicle cabin and the second pinout matrix connects the plurality of sets of power receptacles to the body control module; and
as a result of the second housing detaching from the first housing by unlocking the at least one second attachment member from the at least one first attachment member, the plurality of sets of power receptacles are detached from the vehicle cabin and disconnected from the body control module.

2. The power distribution assembly of claim 1, wherein the second housing comprises a device mounting surface sized and shaped to receive and support a device mount thereon and at least one electronic user device attached to the device mount.

3. The power distribution assembly of claim 2, wherein as the result of the at least one second attachment member locking to the at least one first attachment member, the second pinout matrix connects to the first pinout matrix for supplying data and power from at least one data and power source inside the vehicle to the at least one electronic user device that is plugged into at least one of the plurality of sets of power receptacles.

4. The power distribution assembly of claim 2, wherein the device mounting surface comprises a threaded quick-release attachment for the device mount.

5. The power distribution assembly of claim 1, wherein each set of the plurality of sets of power receptacles are different from one another.

6. The power distribution assembly of claim 1, wherein the plurality of sets of power receptacles comprises a first set of charging ports, a second set of three-prong power outlets and a third set of display ports.

7. The power distribution assembly of claim 1, wherein one of the at least one first and second attachment members is a female attachment member and the other of the at least one first and second attachment members is a mating male attachment member.

8. The power distribution assembly of claim 1, wherein the at least one second attachment member rotationally locks to the at least one first attachment member.

9. The power distribution assembly of claim 1, wherein the rear side of the second housing is sized and shape to mate with a front side of the first housing when the at least one second and first attachment members are locked together.

10. The power distribution assembly of claim 9, wherein the second housing is sized and shaped to conceal the first housing when the at least one second and first attachment members are locked together.

11. A power distribution assembly for a vehicle comprising:
an electrical distribution port located in a first housing mounted on an interior surface of a vehicle cabin, the first housing having at least one first attachment member and the electrical distribution port having a first pinout matrix extending from inside the first housing toward an interior of the vehicle cabin and a body wire harness extending from the inside of the first housing away from the interior of the vehicle cabin, the body wire harness connecting the first pinout matrix to a body control module; and
wherein a power distribution mount located inside a second housing is removably attachable to the first housing, the second housing having at least one second attachment member and the power distribution mount having a second pinout matrix at a rear side of the second housing and a plurality of sets of power receptacles at a front side of the second housing opposite the rear side of the second housing;
wherein as a result of the second housing attaching to the first housing by locking the at least one second attachment member to the at least one first attachment member, the plurality of sets of power receptacles are attached to the vehicle cabin and the second pinout matrix connects the plurality of sets of power receptacles to the body control module; and
wherein as a result of the second housing detaching from the first housing by unlocking the at least one second attachment member from the at least one first attachment member, the plurality of sets of power receptacles are detached from the vehicle cabin and disconnected from the body control module.

12. The power distribution assembly of claim 11, wherein the electrical distribution port comprises a connector configured to connect the body wire harness to the body control module.

13. The power distribution assembly of claim 11, wherein as the result of the at least one second attachment member locking to the at least one first attachment member, the second pinout matrix connects to the first pinout matrix for supplying data and power from at least one data and power source inside the vehicle to at least one electronic user device that is plugged into at least one of the plurality of sets of power receptacles.

14. The power distribution assembly of claim 13, wherein one of the at least one first and second attachment members is a female attachment member and the other of the at least one first and second attachment members is a mating male attachment member.

15. A power distribution assembly for a vehicle comprising:
an electrical distribution port located in a first housing mounted on an interior surface of a vehicle cabin, the first housing having at least one first attachment member and the electrical distribution port having a first pinout matrix extending from inside the first housing toward an interior of the vehicle cabin and a body wire harness extending from the inside of the first housing away from the interior of the vehicle cabin; and
a power distribution mount located in a second housing that is removably attachable to the first housing, the second housing having at least one second attachment member and the power distribution mount having a second pinout matrix at a rear side of the second housing and a plurality of sets of power receptacles at a front side of the second housing opposite the rear side of the second housing;
as a result of the second housing attaching to the first housing by locking the at least one second attachment member to the at least one first attachment member, the plurality of sets of power receptacles are attached to the vehicle cabin and the second pinout matrix connects the plurality of sets of power receptacles to the first pinout matrix; and
as a result of the second housing detaching from the first housing by unlocking the at least one second attachment member from the at least one first attachment member, the plurality of sets of power receptacles are detached from the vehicle cabin and disconnected from the first pinout matrix.

16. The power distribution assembly of claim 15, wherein as the result of the at least one second attachment member locking to the at least one first attachment member, the second pinout matrix connects to the first pinout matrix for supplying data and power from at least one data and power source inside the vehicle to at least one electronic user device that is plugged into at least one of the plurality of sets of power receptacles.

17. The power distribution assembly of claim 16, wherein each set of the plurality of sets of power receptacles are different from one another.

18. The power distribution assembly of claim 17, wherein one of the at least one first and second attachment members is a female attachment member and the other of the at least one first and second attachment members is a mating male attachment member.

19. The power distribution assembly of claim 18, wherein the rear side of the second housing is sized and shape to mate with a front side of the first housing when the at least one second and first attachment members are locked together.

20. The power distribution assembly of claim 19, wherein the second housing is sized and shaped to conceal the first housing when the at least one second and first attachment members are locked together.
